(19) United States
(12) Patent Application Publication
(10) Pub. No.: US 2018/0048791 A1
(43) Pub. Date: Feb. 15, 2018

(54) Image Reflecting and Capturing Assembly

(71) Applicant: Aaron Johnson, Bronx, NY (US)

(72) Inventor: Aaron Johnson, Bronx, NY (US)

(21) Appl. No.: 15/233,281

(22) Filed: Aug. 10, 2016

(51) Int. Cl. H04N 5/225; G03B 17/40; G03B 31/00; G02B 5/08; H04N 5/247; G06F 3/16

(52) U.S. Cl. CPC H04N 5/2252; H04N 5/247; H04N 5/2256; G06F 3/16; G03B 31/00; G02B 5/08; G03B 17/40

(57) ABSTRACT

An image reflecting and capturing assembly for self-imaging includes a frame that defines an inner field. The inner field is reflective. A power module, a microprocessor, a plurality of microphones, a plurality of cameras and a plurality of lights are coupled to and positioned in the frame. The microprocessor is operationally coupled to the power module. The microphones, cameras and lights are operationally coupled to the microprocessor. The lights are configured to illuminate a user positioned proximate to the frame. A user positioned substantially perpendicular to the inner field is positioned to view a reflection of the user. The microphones are configured to capture sounds produced proximate to the frame. The cameras are configured to capture still and moving images of a user positioned proximate to the frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to image capturing assemblies and more particularly pertains to a new image capturing assembly for self-imaging.

### BRIEF SUMMARY OF THE INVENTION

An embodiment of the disclosure meets the needs presented above by generally comprising a frame that defines an inner field. The inner field is reflective. A power module, a microprocessor, a plurality of microphones, a plurality of cameras and a plurality of lights are coupled to and positioned in the frame. The microprocessor is operationally coupled to the power module. The microphones, cameras and lights are operationally coupled to the microprocessor. The lights are configured to illuminate a user positioned proximate to the frame. A user positioned substantially perpendicular to the inner field is positioned to view a reflection of the user. The microphones are configured to capture sounds produced proximate to the frame. The cameras are configured to capture still and moving images of a user positioned proximate to the frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an image reflecting and capturing assembly according to an embodiment of the disclosure.

FIG. 2 is a rear view of an embodiment of the disclosure.

FIG. 3 is a cross-sectional view of an embodiment of the disclosure.

FIG. 4 is an in-use view of an embodiment of the disclosure.

FIG. 5 is a block diagram of an embodiment of the disclosure.

### DETAILED DESCRIPTION OF THE INVENTION

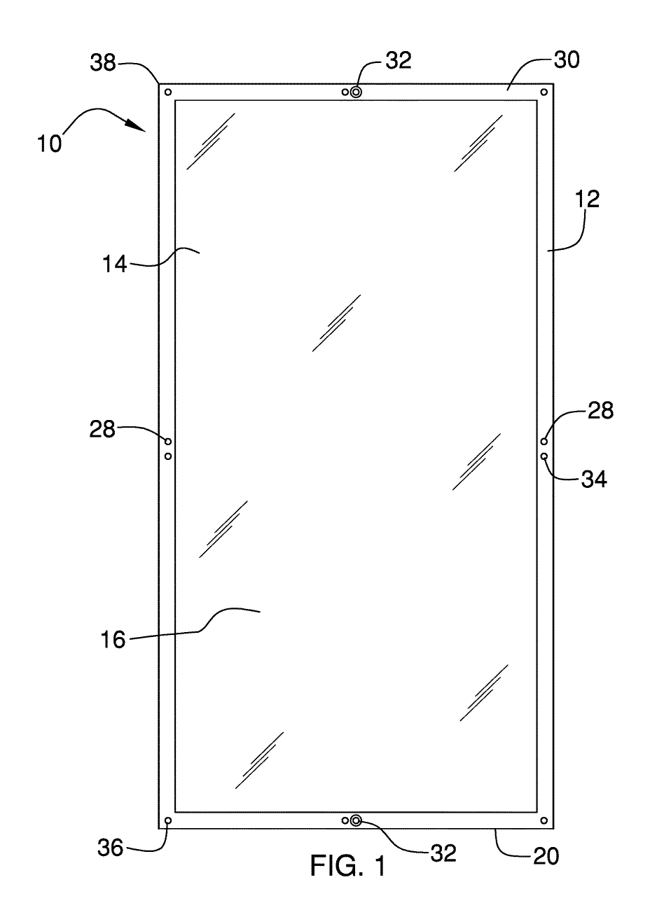

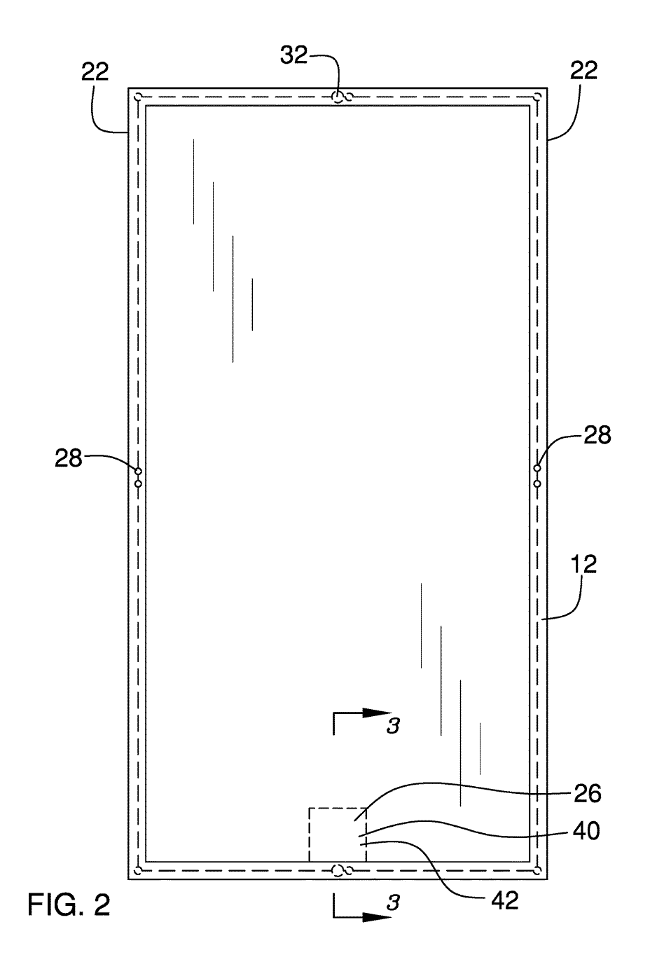

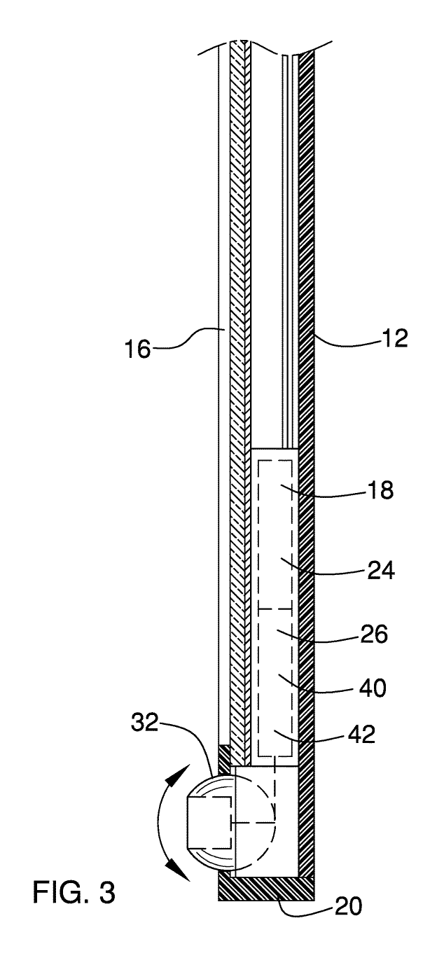

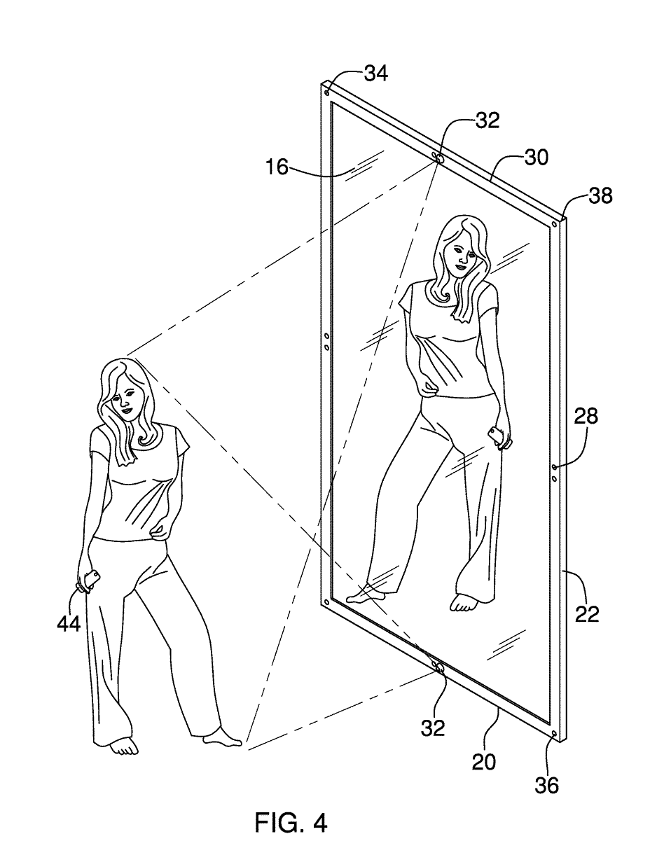

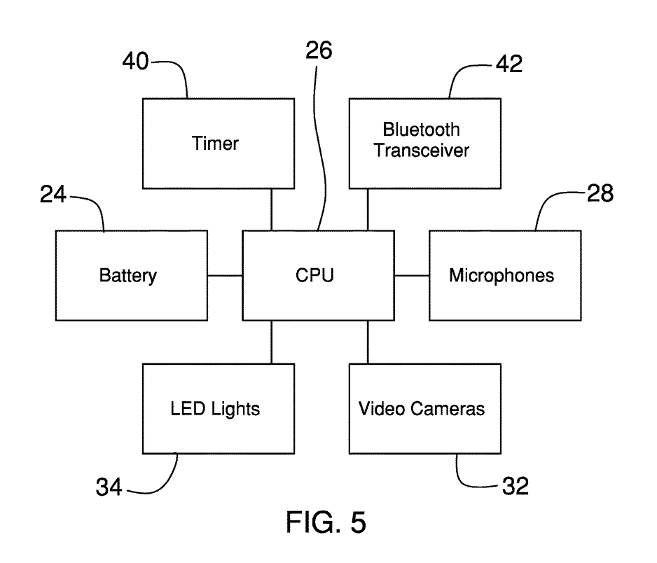

With reference now to the drawings, and in particular to FIGS. 1 through 5 thereof, a new image capturing assembly embodying the principles and concepts of an embodiment of the disclosure and generally designated by the reference numeral 10 will be described.

As best illustrated in FIGS. 1 through 5, the image reflecting and capturing assembly 10 generally comprises a frame 12 that defines an inner field 14. The inner field 14 is reflective, such that a user positioned substantially perpendicular to the inner field 14 is positioned to view a reflection of the user. In one embodiment, the inner field 14 comprises a mirror 16. In another embodiment, the mirror 16 comprises glass. In yet another embodiment, the frame 12 is substantially rectangularly shaped.

A power module 18 is coupled to and positioned in the frame 12. In one embodiment, the power module 18 is positioned in a bottom 20 of the frame 12 substantially equally distant from opposing sides 22 of the frame 12. In another embodiment, the power module 18 comprises at least one battery 24.

A microprocessor 26 is coupled to and positioned in the frame 12. The microprocessor 26 is operationally coupled to the power module 18. The microprocessor 26 is positioned in the frame 12 proximate to the power module 18.

A plurality of microphones 28 is coupled to and positioned in the frame 12. The microphones 28 are operationally coupled to the microprocessor 26. The microphones 28 are positioned in the frame 12 such that the microphones 28 are configured to capture sounds produced proximate to the frame 12. In one embodiment, the plurality of microphones 28 comprises microphones 28 positioned singly in the opposing sides 22 of the frame 12 substantially equally distant from a top 30 and the bottom 20 of the frame 12.

A plurality of cameras 32 is coupled to and positioned in the frame 12. The cameras 32 are operationally coupled to the microprocessor 26. The cameras 32 are positioned in the frame 12 such that the cameras 32 are configured to capture still and moving images of a user positioned proximate to the frame 12. In one embodiment, the cameras 32 are pivotable, such that the cameras 32 are differentially configurable to capture images of a user. In another embodiment, the plurality of cameras 32 comprises cameras 32 positioned singly in the top 30 and the bottom 20 of the frame 12 substantially equally distant from the opposing sides 22 of the frame 12.

A plurality of lights 34 is coupled to and positioned in the frame 12. The lights 34 are operationally coupled to the microprocessor 26. The lights 34 are positioned in the frame 12 such that the lights 34 are configured to illuminate a user positioned proximate to the frame 12. In one embodiment, the lights 34 comprise light emitting diodes 36. In another embodiment, the plurality of lights 34 comprises lights 34 positioned proximate to each corner 38 of the frame 12, lights 34 positioned singly in the top 30 and the bottom 20 substantially equally distant from the opposing sides 22 of the frame 12, and lights 34 positioned singly in the opposing sides 22 substantially equally distant from the top 30 and the bottom 20 of the frame 12. In yet another embodiment, the lights 34 are selectively couplable to the power module 18 through the microprocessor 26. The microprocessor 26 is positioned to selectively couple the lights 34 to the power module 18 such that the lights 34 are selectively illuminable.

A timer 40 is coupled to and positioned in the frame 12. The timer 40 is operationally coupled to the microprocessor 26. The timer 40 is positioned to motivate the plurality of cameras 32 to capture images at an interval selectable by the user.

A transceiver 42 is coupled to and positioned in the frame 12. The transceiver 42 is operationally coupled to the microprocessor 26. The transceiver 42 is wireless. In one embodiment, the transceiver 42 is Bluetooth enabled.

Programming code 44 is positioned on an electronic device of the user. The programming code 44 enables the user to signal the microprocessor 26 via the transceiver 42. The electronic device is configured for the user to signal the microprocessor 26 to selectively motivate the plurality of cameras 32 to capture images and to signal the plurality of microphones 28 to capture sound. The images and sounds are relayed from the microprocessor 26 to the electronic device. The programming code 44 also enables the user to signal the microprocessor 26 to motivate the plurality of lights 34 to illuminate the user and to compel the timer 40 to delay image capture.

In use, the lights 34 are configured to illuminate a user positioned proximate to the frame 12. A user who is positioned substantially perpendicular to the inner field 14 is positioned to view a reflection of the user. The microphones 28 are configured to capture sounds produced proximate to the frame 12. The cameras 32 are configured to capture still and moving images of a user positioned proximate to the frame 12. The programming code 44 enables the user to signal the microprocessor 26, via the transceiver 42, such that the user can signal the microprocessor 26 to selectively motivate the plurality of cameras 32 to capture images and the plurality of microphones 28 to capture sound. The images and sounds are relayed from the microprocessor 26 to the electronic device. The programming code 44 also enables the user to signal the microprocessor 26 to motivate the plurality of lights 34 to illuminate the user and to compel the timer 40 to delay image capture.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An image reflecting and capturing assembly comprising:
a frame defining an inner field, said inner field being reflective;
a power module coupled to and positioned in said frame;
a microprocessor coupled to and positioned in said frame, said microprocessor being operationally coupled to said power module;
a plurality of microphones coupled to and positioned in said frame, said microphones being operationally coupled to said microprocessor;
a plurality of cameras coupled to and positioned in said frame, said cameras being operationally coupled to said microprocessor;
a plurality of lights coupled to and positioned in said frame, said lights being operationally coupled to said microprocessor; and
wherein said lights are positioned in said frame such that said lights are configured to illuminate a user positioned proximate to said frame, wherein a user positioned substantially perpendicular to said inner field is positioned to view a reflection of the user, wherein said microphones are positioned in said frame such that said microphones are configured to capture sounds produced proximate to said frame, wherein said cameras are positioned in said frame such that said cameras are configured to capture still and moving images of a user positioned proximate to said frame.

2. The assembly of claim 1, further including said inner field comprising a mirror.

3. The assembly of claim 2, further including said mirror comprising glass.

4. The assembly of claim 1, further including said frame being substantially rectangularly shaped.

5. The assembly of claim 1, further comprising:
said power module being positioned in a bottom of said frame substantially equally distant from opposing sides of said frame; and
said microprocessor being positioned in said frame proximate to said power module.

6. The assembly of claim 1, further including said power module comprising at least one battery.

7. The assembly of claim 1, further including said plurality of microphones comprising said microphones positioned singly in opposing sides of said frame substantially equally distant from a top and a bottom of said frame.

8. The assembly of claim 1, further including said cameras being pivotable, wherein said cameras are differentially configurable to capture images of a user.

9. The assembly of claim 1, further including said plurality of cameras comprising said cameras positioned singly in a top and a bottom of said frame substantially equally distant from opposing sides of said frame.

10. The assembly of claim 1, further including said lights comprising light emitting diodes.

11. The assembly of claim 1, further including said plurality of lights comprising said lights positioned proximate to each corner of said frame, said lights positioned singly in a top and a bottom substantially equally distant from opposing sides of said frame, and said lights positioned singly in said opposing sides substantially equally distant from said top and said bottom of said frame.

12. The assembly of claim 1, further including said lights being selectively couplable to said power module through said microprocessor, wherein said microprocessor is positioned to selectively couple said lights to said power module such that said lights are selectively illuminable.

13. The assembly of claim 1, further including a timer coupled to and positioned in said frame, said timer being operationally coupled to said microprocessor, wherein said timer is positioned to motivate said plurality of cameras to capture images at an interval selectable by the user.

14. The assembly of claim 1, further including a transceiver coupled to and positioned in said frame, said transceiver being operationally coupled to said microprocessor, said transceiver being wireless.

15. The assembly of claim 14, further including said transceiver being Bluetooth enabled.

16. The assembly of claim 14, further including programming code positioned on an electronic device of the user, said programming code enabling the user to signal said microprocessor via said transceiver, such that the electronic device is configured for the user to signal said microprocessor to selectively motivate said plurality of cameras to capture images and said plurality of microphones to capture sound, wherein the images and sounds are relayed from said microprocessor to the electronic device, said programming code enabling the user to signal said microprocessor via said transceiver to motivate said plurality of lights to illuminate the user and to compel said timer to delay image capture.

17. An image reflecting and capturing assembly comprising:
a frame defining an inner field, said inner field being reflective, wherein a user positioned substantially perpendicular to said inner field is positioned to view a reflection of the user, said inner field comprising a mirror, said mirror comprising glass, said frame being substantially rectangularly shaped;
a power module coupled to and positioned in said frame, said power module being positioned in a bottom of said frame substantially equally distant from opposing sides of said frame, said power module comprising at least one battery;
a microprocessor coupled to and positioned in said frame, said microprocessor being operationally coupled to said power module, said microprocessor being positioned in said frame proximate to said power module;
a plurality of microphones coupled to and positioned in said frame, said microphones being operationally coupled to said microprocessor, wherein said microphones are positioned in said frame such that said microphones are configured to capture sounds produced proximate to said frame, said plurality of microphones comprising said microphones positioned singly in said opposing sides of said frame substantially equally distant from a top and said bottom of said frame;
a plurality of cameras coupled to and positioned in said frame, said cameras being operationally coupled to said microprocessor, wherein said cameras are positioned in said frame such that said cameras are configured to capture still and moving images of a user positioned proximate to said frame, said cameras being pivotable, wherein said cameras are differentially configurable to capture images of a user, said plurality of cameras comprising said cameras positioned singly in said top and said bottom of said frame substantially equally distant from said opposing sides of said frame;
a plurality of lights coupled to and positioned in said frame, said lights being operationally coupled to said microprocessor, wherein said lights are positioned in said frame such that said lights are configured to illuminate a user positioned proximate to said frame, said lights comprising light emitting diodes, said plurality of lights comprising said lights positioned proximate to each corner of said frame, said lights positioned singly in said top and said bottom substantially equally distant from said opposing sides of said frame, and said lights positioned singly in said opposing sides substantially equally distant from said top and said bottom of said frame, said lights being selectively couplable to said power module through said microprocessor, wherein said microprocessor is positioned to selectively couple said lights to said power module such that said lights are selectively illuminable;
a timer coupled to and positioned in said frame, said timer being operationally coupled to said microprocessor, wherein said timer is positioned to motivate said plurality of cameras to capture images at an interval selectable by the user;
a transceiver coupled to and positioned in said frame, said transceiver being operationally coupled to said microprocessor, said transceiver being wireless, said transceiver being Bluetooth enabled;
programming code positioned on an electronic device of the user, said programming code enabling the user to signal said microprocessor via said transceiver, such that the electronic device is configured for the user to signal said microprocessor to selectively motivate said plurality of cameras to capture images and said plurality of microphones to capture sound, wherein the images and sounds are relayed from said microprocessor to the electronic device, said programming code enabling the user to signal said microprocessor via said transceiver to motivate said plurality of lights to illuminate the user and to compel said timer to delay image capture; and
wherein said lights are positioned in said frame such that said lights are configured to illuminate a user positioned proximate to said frame, wherein a user positioned substantially perpendicular to said inner field is positioned to view a reflection of the user, wherein said microphones are positioned in said frame such that said microphones are configured to capture sounds produced proximate to said frame, wherein said cameras are positioned in said frame such that said cameras are configured to capture still and moving images of a user positioned proximate to said frame, wherein said programming code is positioned on an electronic device of the user such that said programming code enables the user to signal said microprocessor via said transceiver, such that the electronic device is configured for the user to signal said microprocessor to selectively motivate said plurality of cameras to capture images and said plurality of microphones to capture sound, wherein the images and sounds are relayed from said microprocessor to the electronic device, said programming code enabling the user to signal said microprocessor via said transceiver to motivate said plurality of lights to illuminate the user and to compel said timer to delay image capture.
